(19) United States
(12) Patent Application Publication
(10) Pub. No.: US 2002/0037033 A1
(43) Pub. Date: Mar. 28, 2002

(54) Serialised test of parallel optical module

(75) Inventor: Jan During, Huddinge (SE)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor AB, Jarfalla (SE)

(21) Appl. No.: 09/956,866

(22) Filed: Sep. 21, 2001

(30) Foreign Application Priority Data
Sep. 22, 2000 (GB) 0023245.4

(51) Int. Cl. H04B 3/46

(52) U.S. Cl. 375/224; 359/110

(57) ABSTRACT

A method and system for measuring performance characteristics such as bit error rate (BER) in a multiple parallel-channel digital communications system. A transmitter such as a VCSEL array outputs multiple, high data rate, digital signals onto an appropriate media for reception at a receiving end. The test architecture uses a test pattern generator at the transmitter end and a data re-shaper connected to a receiver in each channel. The output of each re-shaper is serially connected back into the next channel transmitter until each channel has been tested. An error detector connected serially to the last receiver provides an evaluation of the characteristics of the multiple channels.

### FIELD OF THE INVENTION

This invention relates to digital communications systems and more particularly to methods and systems for efficiently measuring performance characteristics in multiple, parallel-channel optical transceivers.

### BACKGROUND

Ongoing developments in the field of information technology and in particular multimedia applications have resulted in considerable growth in broadband systems with the resulting demand to increase network data rates. The high speed capabilities of optical devices, including vertical cavity surface emitting lasers (VCSELs) have made such devices prime candidates for delivering high data rate signals. One application for such devices is in a multiple, parallel channel architecture wherein data is input on parallel links and transmitted over a transmission media to a receiver at the destination end. The digitized data is transported over such transmission media as optical fibers, twisted pairs, co-axial cables or for short distances through the air. For optical fibers and for transmission through the air, optical energy from the optical devices is modulated directly to provide an efficient data transmitter. In the more conventional twisted pair or coaxial cables the optical signal is converted to an electrical signal and carried over electrical conductors to the destination.

Due to the miniaturization possible with optical sources, such as VCSELs, multiple transmitters can be used in a parallel architecture wherein each link or channel carries different data streams.

Since optical transmitters, and indeed all components in a transmission system including receivers and transceiver architectures, are subject to numerous sources of variation it is frequently desirable and indeed necessary to test the digital parallel links both on initialization and periodically during operation. A typical test set up for a single channel includes a pattern generator to produce a digital test pattern which is provided to a transmitter, passed through the transmission media to a receiver and subsequently tested using an error detector at the receiver end. Typically, when conducting parallel bit error rate measurements on a parallel transmitter module with multiple channels, a separate pattern generator is required for each channel and a separate error detector for each channel is situated at the receiver end. This test architecture necessitates excessive use of resources as a separate pattern generator and a separate error detector is required for each channel. Additionally, the testing of each channel is done separately which for a multiple channel structure can result in considerable testing time.

Accordingly, there is a need for an improved method and system for measuring system parameters in a multiple, parallel channel digital communications network.

### SUMMARY OF THE INVENTION

The present invention seeks to address the above identified problem by minimizing test equipment and decreasing the test times for transmission system measurements.

Therefore, in accordance with a first aspect of the present invention there is provided a method of testing performance characteristics of a digital communications system having N parallel channels, the method comprising: providing a test pattern to a transmitter and transmitting the test pattern over a first channel; receiving and reshaping the test pattern; serially re-transmitting the reshaped test pattern over a second channel; repeating steps b) and c) up to channel N-1; re-transmitting the reshaped test pattern over channel N to a receiver; and evaluating the received reshaped test pattern.

In accordance with second aspect of the invention there is provided a system for testing performance characteristics of a digital communications system having N parallel channels, the system comprising: a test pattern generator to generate a test pattern; a parallel transmitter to transmit the test pattern sequentially over each of the multiple channels beginning with the first channel; a receiver in each channel for receiving the test pattern; a data re-shaper in each channel up to channel N-1 and connected serially to the receiver for reshaping the received test pattern; means to serially provide the reshaped test pattern to the parallel transmitter for transmission over subsequent channels up to channel N; and an error detector serially connected to the receiver in channel N for evaluating the received test pattern.

### BRIEF DESCRIPTION OF THE DRAWINGS

The invention will now be described in greater detail with reference to the attached drawings wherein:

FIG. 1 is a block diagram of a circuit for bit error rate measurements of a single channel transmitter module;

FIG. 2 is a block diagram of a parallel bit error rate measurement of a parallel transmitter module with N channels; and

FIG. 3 is a block diagram of a serialized bit error rate measurement of a parallel transmitter module with N channels according to the present invention.

### DETAILED DESCRIPTION OF THE INVENTION

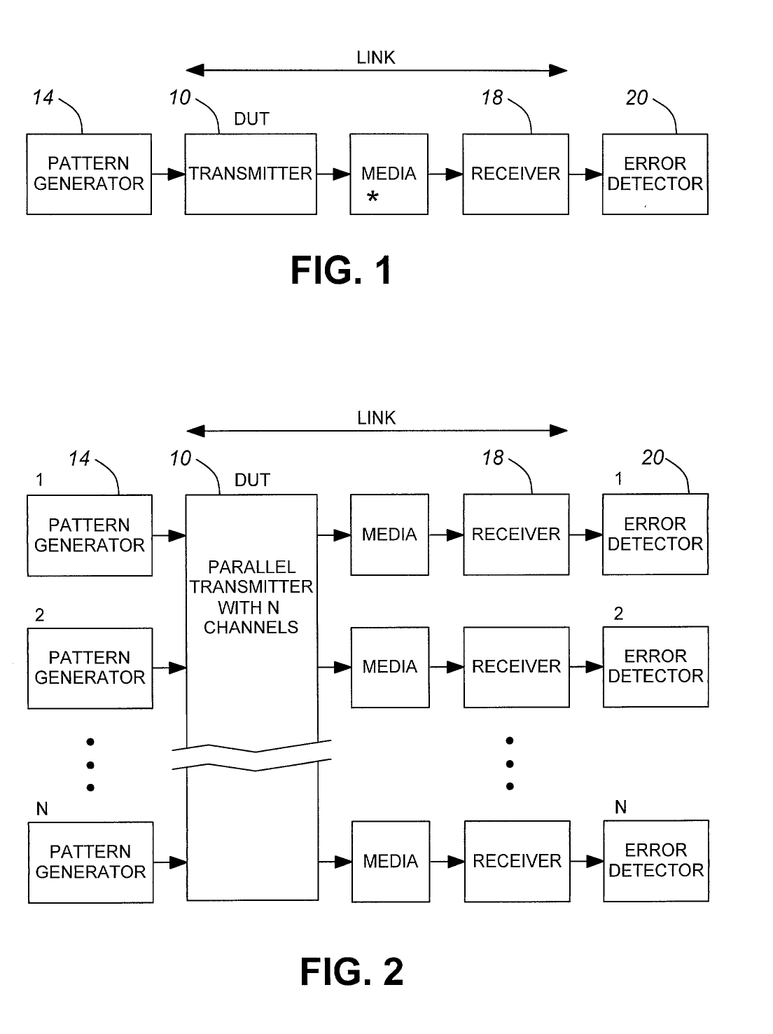

FIG. 1 provides a block diagram of the system architecture used for measuring performance characteristics, such as bit error rate, of a single channel transmitter module. A transmitter 10 which may be, for example, a single element VCSEL receives a test signal from pattern generator 14. The transmitter outputs the optical signal over a transmission media that may be, for example, an optical fiber cable or an air link. If an alternate media such as a twisted pair or coaxial cable is used the transmitter will include a converter to convert the optical signal to an electrical signal prior to being transmitted through the media. At receiver 18 the optical signal is received and converted to an electrical signal. If the received signal is already in an electrical form it is received and amplified as is well known. An error detector 20 is used at the output of the receiver to test characteristics such as bit error rate, jitter etc.

FIG. 2 illustrates a system for testing system characteristics of transmission architecture having multiple channels with a parallel transmitter for outputting individual channels onto each link. As shown the system includes channels 1 to N each having its own pattern generator and its own error detector.

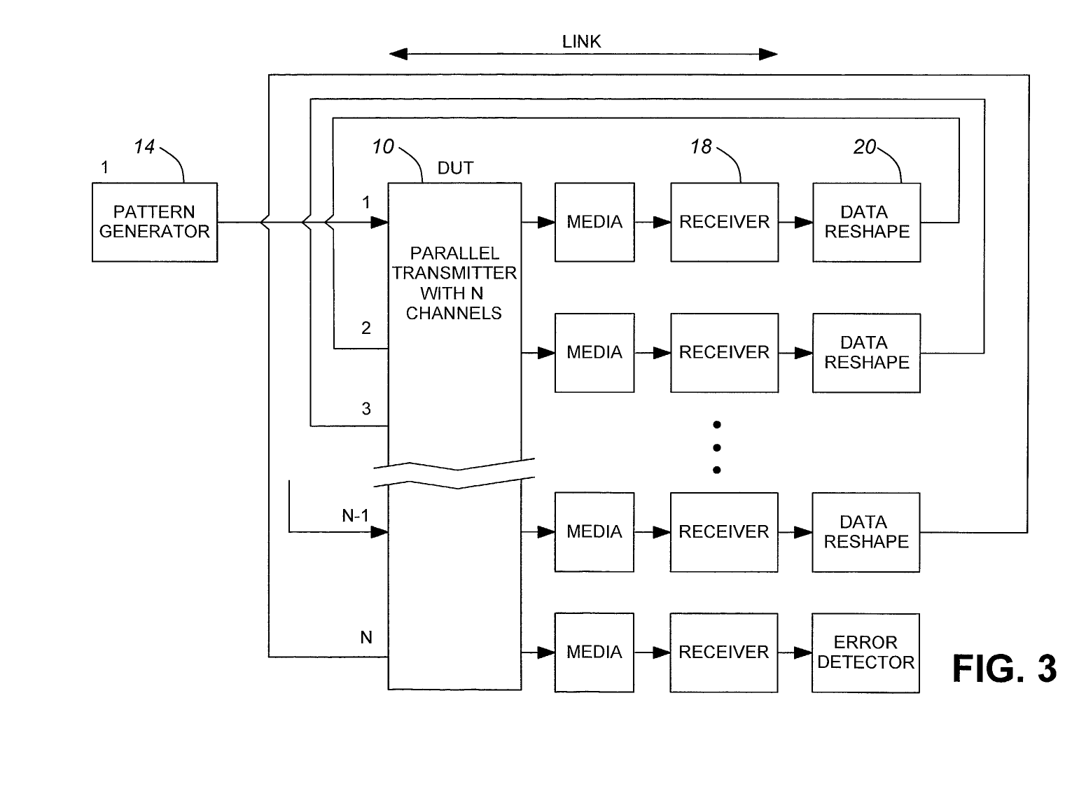

FIG. 3 is a block diagram of a serialized bit error rate measurement of a parallel transmitter module again with N channels according to a preferred aspect of the present invention. As shown in FIG. 3 a single pattern generator and a single error detector are required. Each channel, however, is provided with a data re-shaper that is serially connected to the receiver. The reshape circuit is required in as much as the signal tends to degrade as it passes through a channel or link. Without the reshape circuit it is possible that the signal will degrade to the point that the error detector at the end of the serialized link can't reliably detect the data in the test pattern generated by the pattern generator.

As shown in FIG. 3, the pattern generator provides a test signal to the parallel transmitter that outputs the signal on the first channel. The test signal is then transmitted over the media to the receiver and then data reshaped. The output of the data re-shaper is fed back serially to channel 2 and the process continues sequentially through each channel to N-1 with the output of a data re-shaper at N-1 coupled back into channel N. The output of the transmitter associated with channel N is received and subsequently fed to the error detector to perform the requested test procedure.

With the test set up as shown in FIG. 3 it is possible to make a bit error measurement for a parallel optical module simultaneously on each channel.

The system can be used to conduct various test measurements such as bit error rate testing measurements, jitter measurements, eye diagram measurements and combinations of these various measurements.

As shown in FIG. 3 the system includes a transmitter and a receiver but it is to be understood that the test procedure can be used to test individually, digital parallel transmitters, digital parallel receivers as well as digital parallel transceivers.

While specific embodiments of the invention have been described and illustrated it will be apparent to one skilled in the art that numerous alternatives and variations can be implemented without departing from the basic concept of the invention. It is to be understood, however, that such alternatives and variations will fall within the true scope of the invention as defined in the appended claims.

1. A method of testing performance characteristics of a digital communications system having N parallel channels, the method comprising:
a) providing a test pattern to a transmitter and transmitting the test pattern over a first channel;
b) receiving and reshaping the test pattern;
c) serially re-transmitting the reshaped test pattern over a next channel;
d) repeating steps b) and c) up to channel N-1;
e) re-transmitting the reshaped test pattern over channel N to a receiver; and
f) evaluating the received, reshaped test pattern.

2. The method as defined in claim 1 for serially measuring bit error rates (BER) in a multiple parallel-channel digital communications system.

3. The method as defined in claim 1 for serially measuring jitter in a multiple parallel-channel digital communications system.

4. The method as defined in claim 1 for serially measuring eye diagrams in a multiple parallel-channel digital communications system.

5. The method as defined in claim 1 for serially measuring combinations of bit error rates, jitter and eye diagrams in a multiple parallel-channel digital communications system.

6. The method as defined in claim 1 for testing performance of transmitters in a multiple parallel-channel digital communications system.

7. The method as defined in claim 1 for testing performance of receivers in a multiple parallel-channel digital communications system.

8. The method as defined in claim 1 for testing performance of transceivers in a multiple parallel-channel digital communications system.

9. A system for testing performance characteristics of a digital communications system having N parallel channels, the system comprising:
a) a test pattern generator to generate a test pattern;
b) a parallel transmitter to transmit a test pattern generated by said test pattern generator sequentially over each of the multiple channels beginning with the first channel;
c) a receiver in each channel for receiving the test pattern;
d) a data re-shaper in each channel up to channel N-1 and connected serially to the receiver for reshaping the received test pattern;
e) means to serially provide the reshaped test pattern to the parallel transmitter for transmission over subsequent channels up to channel N; and
f) an error detector serially connected to the receiver in channel N for evaluating the received test pattern.

10. The system as defined in claim 9 for testing performance characteristics of transmitters in a multiple parallel-channel digital communications system.

11. The system as defined in claim 9 for testing performance characteristics of receivers in a multiple parallel-channel digital communications system.

12. The system as defined in claim 9 for testing performance characteristics of transceivers in a multiple parallel-channel digital communications system.

13. The system as defined in claim 9 wherein said error detector has means to measure bit error rates (BERs).

14. The system as defined in claim 9 wherein said error detector has means to measure jitter.

15. The system as defined in claim 9 wherein said error detector has means to measure eye diagrams.

16. The system as defined in claim 9 wherein said error detector has means to measure combinations of BER, jitter and eye diagrams.
